(19) United States
(12) Patent Application Publication
(10) Pub. No.: US 2024/0317593 A1
(43) Pub. Date: Sep. 26, 2024

(54) METHOD OF MASS-PRODUCING SILICON OXIDE (SiOx) POWDER AND ANODE FOR LITHIUM-ION BATTERIES

(71) Applicant: Honeycomb Battery Company, Dayton, OH (US)

(72) Inventor: Bor Z. Jang, Centerville, OH (US)

(73) Assignee: Honeycomb Battery Company, Dayton, OH (US)

(21) Appl. No.: 18/188,889

(22) Filed: Mar. 23, 2023

(51) Int. Cl. C01B 33/18; H01M 10/0525; H01M 50/46

(52) U.S. Cl. CPC C01B 33/18; H01M 10/0525; H01M 50/46; C01P 2004/80

(57) ABSTRACT

A method of producing multiple particles of silicon oxide SiOₓ, including (a) preparing a plurality of silicon alloy particles M_{y}Si, wherein M is a metal or semi-metal element present on a surface or in the interior of a silicon particle; (b) heating the silicon alloy particles to a first temperature to form a plurality of composite particles, wherein a composite particle comprises a layer of silicon dioxide, SiO₂, at least partially covering or encapsulating an underlying silicon alloy particle; (c) heating the composite particles to a second temperature under a vacuum or protective inert atmosphere, allowing the silicon dioxide to react with the underlying silicon alloy to form substantially silicon oxide having M dispersed therein and vaporizing the silicon oxide; and (d) cooling the silicon oxide vapor to form solid silicon oxide and using mechanical means to make the solid silicon oxide into multiple particles of silicon oxide.

### FIELD

This invention relates generally to a method of producing silicon oxide (SiOₓ, 0<x<2) powders and more particularly to a method of mass-producing modified silicon oxide powders for lithium-ion battery anode applications.

### BACKGROUND

A lithium ion battery is a prime candidate energy storage device for electric vehicle (EV), renewable energy storage, and smart grid applications. Graphite materials have been widely used as an anode (negative electrode) active material for commercial lithium ion batteries due to their relatively low cost and excellent reversibility. However, the theoretical lithium storage capacity of graphite is only 372 mAh/g (based on LiC₆), which can limit the total capacity and energy density of a battery cell. The emerging EV and renewable energy industries demand the availability of rechargeable batteries with a significantly higher energy density and power density than what the current Li ion battery technology can provide. Hence, this requirement has triggered considerable research efforts on the development of electrode materials with higher specific capacity, excellent rate capability, and good cycle stability for lithium ion batteries.

Several elements from Group III, IV, and V in the periodic table can form alloys with Li at certain desired voltages. Therefore, various anode materials based on such elements and some metal oxides (e.g., SnO₂) have been proposed for lithium ion batteries. Among these, silicon is considered the most promising one since it has the highest theoretical specific capacity (up to 4,200 mAh/g in the stoichiometric form of Li_{4.4}Si) and low discharge potential (i.e., high operation potential when paired with a cathode). However, the dramatic volume change (up to 380%) of Si during lithium ion alloying and de-alloying (cell charge and discharge) often leads to severe and rapid battery performance deterioration. The performance fade (hence, a short cycle life) is mainly due to the volume change-induced pulverization of Si and the inability of the binder/conductive additive to maintain the electrical contact between the pulverized Si particles and the current collector.

Silicon oxide (SiOₓ, 0<x<2) has been considered as a good alternative anode material to silicon (Si) owing to its significantly better cycling stability. The SiOₓ powder is commonly obtained by heating a mixture of silicon dioxide (SiO₂) particles and silicon particles to generate SiOₓ gas, and the cooling the generated SiOₓ gas to obtain a solid deposit on a substrate, followed by finely pulverizing the deposit.

Due to poor electrical conductivity. SiOₓ materials are seldom used as the sole anode active material in an anode; instead, SiOₓ particles are typically mixed with graphite particles. It has been generally difficult to mix SiOₓ and graphite particles to form an anode that has a high packing density, homogeneous mixing, and good cycle life. We have observed that SiO particles that are sub-micron in size (diameter<1 μm, preferably <500 nm, further preferably <200 nm, and most preferably from 20 to 100 nm) are more effective in forming a more homogeneous mixture with graphite particles for improving these battery characteristics.

The prior art processes are not capable of producing SiOₓ particles that are sub-micron in size. The pulverization procedure (e.g., ball milling and air jet milling) only produces a high proportion of particles that are typically very large in size. Further, the process of producing silicon dioxide (SiO₂) particles and silicon particles on a separate basis and then mixing these two types of solid particles together typically led to inhomogeneous mixtures, resulting in SiOₓ particles that are inconsistent in quality. This is a highly undesirable feature for lithium-ion battery anode application.

Another major issue associated with the SiOₓ particles produced by the prior art methods is a low first-cycle coulombic efficiency (typically lower than 80%, more typically lower than 75%, and most typically from 68% to 72%). This implies that one can loss 20-32% of the lithium storage capacity after the first charge/discharge cycle.

Yet another major issue associated with the SiOₓ particles produced by the prior art methods is their high volume expansion (up to 200%). Although lower than the volume expansion of pure Si (300%-380%), a volume expansion of up to 200% can still lead to an excessive expansion of the anode and the entire battery cell. This is a highly undesirable outcome for a battery to be used in an EV or consumer electronic device.

There is a clear need to have a better method of producing SiOₓ particles that impart better efficiency, longer cycle life, and smaller volume expansion to an anode or battery cell.

### SUMMARY

The present disclosure provides a method of producing multiple particles of silicon oxide SiOₓ, where 0<x<2, the method comprising: (a) preparing (i) a plurality of silicon alloy particles, M_{y}Si, wherein M is a metal or non-metal element present on a surface of a silicon particle or in the interior of a silicon particle or preparing (ii) a mixture of multiple Si particles and multiple M-containing particles; wherein M is selected from Al, Fe, Zn, Sn, Cu, Mn, Ni, Ti, V, Cr, Co, Zr, Nb, Mo, Ag, Au, Cd, Li, Na, K, Be, Mg, Ca, B, C, Ge, Ga, In, Sb, Bi, N, P, Pb, Se, S, or a combination thereof, and y is selected from 0.001 to 4.4; (b) heating said (i) silicon alloy particles or (ii) mixture of multiple Si particles and multiple M-containing particles to a first temperature for a first period of time to form (iii) a plurality of composite particles or (iv) a mixture of a plurality of composite particles and multiple M-containing particles, wherein a composite particle comprises a layer of silicon dioxide, SiO₂, at least partially covering or encapsulating an underlying silicon alloy or silicon core; (c) heating (iii) the plurality of composite particles or (iv) the mixture to a second temperature under a vacuum or protective inert atmosphere for a second duration of time, allowing the silicon dioxide to react with the underlying silicon alloy or silicon core of a composite particle to form a substantially silicon oxide particle, SiOₓ, having M dispersed therein and vaporizing said silicon oxide to a vapor state; and (d) cooling the silicon oxide vapor to form solid silicon oxide and using mechanical means to make the solid silicon oxide into multiple particles of silicon oxide. Preferably, the first temperature is from 500° C. to 1,000° C. and the second temperature is from 1,200° C. to 1,500° C.

The starting material for this production process is either (i) a plurality of silicon alloy particles, M_{y}Si, wherein M is a metal or non-metal element present on a surface of a silicon particle or in the interior of a silicon particle (e.g., Li- or B-doped Si particles) or (ii) a mixture of multiple Si particles and multiple M-containing particles (e.g., LiOH or boron oxide), or a mixture of (i) and (ii). The process does not begin with mixing a starting material (Si alloy or Si) and SiO₂ particles and the M-containing particles do not include SiO₂. In contrast, the prior art process typically involves mixing Si particles with SiO₂ particles and then heating the resulting mixture to activate chemical reactions between Si and SiO₂ to form SiOₓ. However, it is challenging to mix different solid particles together in a homogeneous or uniform manner. Without good mixing, the reactions between Si and SiO₂ particles cannot occur uniformly and often cannot be completed.

Preferably, in the silicon alloy particles M_{y}Si, y is selected from 0.01 to 1.0 and more preferably from 0.1 to 0.3. The silicon alloy particles preferably have a diameter from 20 nm to 50 μm, further preferably from 50 nm to 10 μm, still more preferably from 80 nm to 20 μm, and most preferably from 100 nm to 1 μm

In certain embodiments, element M, prior to step (b), exists as a single-element metal domain or as a compound of M on a surface or inside the internal structure of a silicon alloy particle.

In certain embodiments, the element M, upon conclusion of step (c) or (d), exists as a single-element metal domain (a small volume substantially consisting of just M atoms) or as a compound of M inside the internal structure of a silicon oxide particle, or as a compound of M on an external surface of the silicon oxide particle. The element M may be introduced to the interior or surface of a silicon alloy particle by using doping, ion implementation, physical vapor deposition, sputtering, atomic layer deposition, chemical vapor deposition, solution deposition, coating, spraying, painting, or a combination thereof.

In some embodiments, the element M, upon conclusion of step (c) or (d), exists as a compound selected from oxide, boride, carbide, nitride, silicide, halogenide, phosphide, or selenide of M, or a combination thereof.

In step (b), a preferred molar ratio of silicon-to-SiO₂ in a composite particle is from 1/100 to 100/1.

In certain embodiments, step (c) is conducted in a first chamber and step (d) is conducted in a first chamber or a second chamber and the method further comprises, during step (c) and/or step (d), a procedure (e) of introducing a carbon precursor gas into the first chamber and/or the second chamber and converting the carbon precursor gas into solid carbon that coats or deposits onto a surface of a silicon oxide particle or encapsulates a silicon oxide particle. The carbon precursor gas may be selected from a hydrocarbon gas (e.g., acetylene, ethylene, propylene, propane, methane, etc.), coal tar pitch gas, petroleum pitch gas, or a combination thereof.

The mechanical means in step (d) may be selected from grinding, mechanical milling, air jet milling, or ball-milling. In certain embodiments, step (c) or step (d) is conducted in a fluidized bed environment to reduce or prevent particle-to-particle bonding, coarsening, or sintering of silicon oxide particles.

The method preferably further comprises a step of coating or encapsulating a silicon oxide particle with a thin layer of carbon or graphene having a thickness from 0.34 nm to 100 nm. The graphene material involved in this method may be selected from pristine graphene, graphene oxide (GO), reduced graphene oxide (RGO), graphene fluoride (GF), graphene bromide (GB), graphene iodide (GI), boron-doped graphene, nitrogen-doped graphene, chemically functionalized graphene, or a combination thereof. The graphene material may include a single-layer or few-layer sheet of pristine graphene, graphene oxide, reduced graphene oxide, graphene fluoride, graphene chloride, graphene bromide, graphene iodide, boron-doped graphene, nitrogen-doped graphene, chemically functionalized graphene, or a combination thereof, wherein few layer is defined as less than 10 layers that are stacked together through van der Waals forces with a typical inter-graphene spacing of approximately 0.335 nm or slightly larger.

In certain embodiments, the present disclosure provides a method of producing multiple particles of silicon oxide SiOₓ, where 0<x<2, the method comprising: (a) preparing a plurality of silicon particles; (b) heating said silicon particles to a first temperature for a first period of time to form a plurality of composite particles, wherein a composite particle comprises a layer of silicon dioxide, SiO₂, at least partially covering or encapsulating an underlying silicon; (c) heating the plurality of composite particles to a second temperature under a vacuum or protective inert atmosphere for a second duration of time, allowing the silicon dioxide to react with the underlying silicon of a composite particle to form a silicon oxide particle and vaporizing said silicon oxide to a vapor state; (d) introducing a stream of a precursor gas containing an element M to mix and react with the silicon oxide vapor to form vapor of M-containing silicon oxide, wherein M is a metal or non-metal element selected from Al, Fc, Zn, Sn, Cu, Mn, Ni, Ti, V, Cr, Co, Zr, Nb, Mo, Ag, Au, Cd, Li, Na, K, Be, Mg, Ca, B, C, Ge, Ga, In, Sb, Bi, N, P, Pb, Sc, S, or a combination thereof, and M is present on a surface of a silicon oxide particle or in the interior of a silicon oxide and the atomic ratio of M-to-Si in the M-containing silicon oxide is selected from 0.001 to 4.4; and (c) cooling the M-containing silicon oxide vapor to form M-containing solid silicon oxide and using mechanical means to make said solid silicon oxide into multiple particles of silicon oxide containing M therein.

The present disclosure also provides an anode active material for lithium-ion batteries, the anode active material comprising a plurality of composite particles wherein at least a composite particle (preferably having a diameter of from 50 nm to 50 μm) comprises (i) one or more than one silicon oxide SiOₓ particle (where 0<x<2), and (ii) a metal or semi-metal element M dispersed in the SiOₓ matrix (the bulk) of the particle or coated on a surface of the SiOₓ particle and M is selected from Al, Fe, Zn, Sn, Cu, Mn, Ni, Ti, V, Cr, Co, Zr, Nb, Mo, Ag, Au, Cd, Li, Na, K, Be, Mg, Ca, B, C, Ge, Ga, In, Sb, Bi, N, P, Pb, Se, S, or a combination thereof, and wherein M is present as individual M atoms embedded in the SiOₓ structure, as a domain or phase comprising multiple M atoms that are dispersed in the SiOₓ structure, or as a compound selected from oxide, boride, carbide, nitride, silicide, halogenide, phosphide, or selenide of M, or a combination thereof.

In some preferred embodiments, in this anode active material, the composite comprises discrete, oxygen-free Si domains or phase dispersed in a SiOₓ matrix wherein the Si domains have a dimension from 2 nm to 200 nm.

In some specific embodiments, the composite particle is a core/shell structure comprising a core of discrete, oxygen-free Si domain or phase encapsulated by a shell of SiOₓ matrix, wherein the Si domain core has a dimension from 10 nm to 200 nm.

Preferably, the composite particle is further encapsulated by or coated with a layer of carbon or graphene.

The present disclosure also provides an anode (negative electrode) for a lithium battery, wherein the anode comprises the disclosed SiOₓ material as an anode material, an optional binder, and an optional conductive additive. The disclosure further provides a lithium battery, wherein the lithium battery comprises the disclosed anode, a cathode, a separator between the anode and the cathode, and an electrolyte in ionic contact with the anode and the cathode. The electrolyte can be a solid-state electrolyte. The electrolyte for the battery, if containing a solid-state electrolyte, can be a separator.

### BRIEF DESCRIPTION OF THE DRAWINGS

FIG. 1(A): A prior art process for producing SiOₓ powder from mixing two previously prepared Si and SiO₂ powders, which are then heated to facilitate reaction between Si and SiO₂ particles to form a bulk deposit of SiOₓ, followed by a pulverization procedure to breakup the deposit into individual particles.

FIG. 1(B): A process for producing uniformly reacted SiOₓ powder begins by heating and surface-oxidizing M-containing Si particles (M_{y}Si) to produce SiO₂-coated M_{y}Si powders, which are then heated to facilitate reaction between SiO₂ and underlying Si to form desirably or fully reacted SiOₓ particles containing a homogeneous microstructure.

FIG. 2: A process flow chart showing preferred routes to prepare silicon oxide powder according to some preferred embodiments.

FIG. 3: Another process flow chart showing preferred routes to prepare silicon oxide powder according to some preferred embodiments.

FIG. 4: Schematic of an apparatus that can be used to produce SiOₓ containing M, according to some preferred embodiments of the present disclosure.

FIG. 5: X-ray diffraction curves of SiOₓ and Li-doped SiOₓ particles.

FIG. 6: Charge (lithiation)/discharge (delithiation) curves of an SiOₓ-based anode in a half cell test and those of an anode of SiOₓ containing a metal M (M=Li herein as an example).

### DETAILED DESCRIPTION

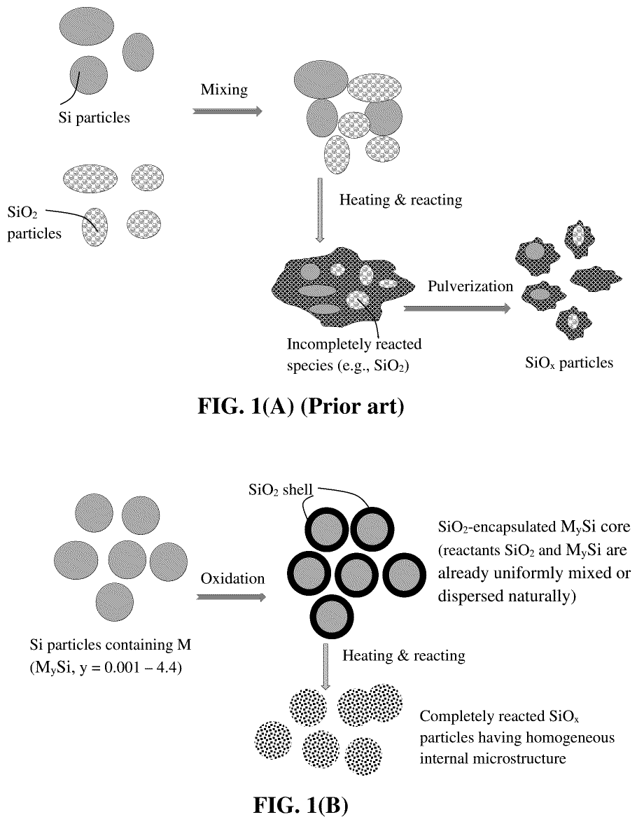

As mentioned earlier, the prior art SiOₓ powder is commonly produced by preparing Si powder and SiO₂ powder (the two primary reactants) separately, which are then physically blended together to form a mixture (illustrated in FIG. 1(A)). This is followed by heating the SiO₂/Si powder mixture to a high temperature (typically 1,250° C. to 1,450° C.), allowing the following reaction to occur: m SiO₂+n Si=(m+n) SiOₓ. The heat also sublimes the reaction product SiOₓ into a gaseous (vapor) state. Typically, the SiOₓ vapor is then cooled and directed to deposit on a solid substrate to obtain a solid deposit thereon. The solid deposit is then scratched off from the substrate and pulverized to become fine particles, typically 1-50 μm in size. This process of first producing silicon dioxide (SiO₂) particles and silicon particles on a separate basis and then mixing these two types of solid particles together often led to inhomogeneous mixtures, resulting in SiOₓ particles that are inconsistent in quality. This is a highly undesirable feature for lithium-ion battery anode application. Uniform mixing of two or three types of solid particles is known to be a challenging task.

As illustrated in FIG. 1(B) as a preferred embodiment, the present disclosure provides a process for cost-effectively producing uniformly reacted SiOₓ powder. This process begins by heating and surface-oxidizing M-containing Si particles (M_{y}Si, y being from 0.001 to 4.4) to produce SiO₂-coated M_{y}Si powders, which are then heated to facilitate reaction between SiO₂ and underlying Si to form desirably or fully reacted SiOₓ particles containing a homogeneous microstructure. By implementing a powder handling procedure (e.g., moving solid particles via a fluidized-bed while a reaction takes place), one can prevent the formation of a deposit bulk, enabling production of individual or small SiOₓ particles even without a subsequent pulverization procedure.

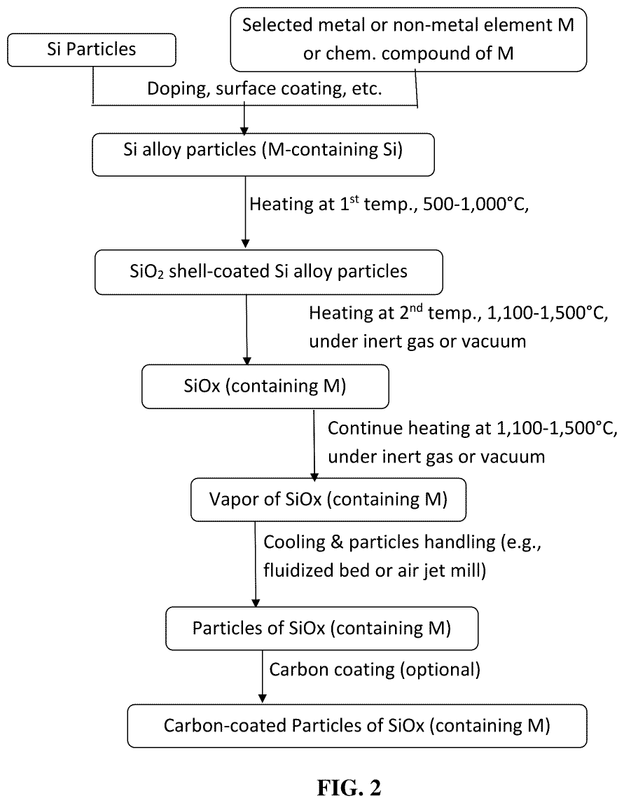

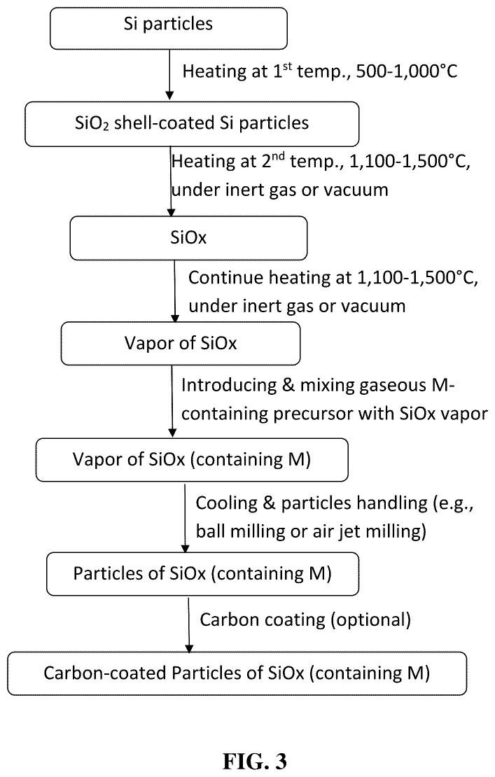

After extensive experimental work and in-depth analysis, we have come to realize that uniform mixing of SiOₓ and Si may be conveniently and effectively achieved by preparing Si particles as the primary starting material and then exposing Si particles to an oxidizing environment (e.g., room air at a temperature of 400-1,000° C.) to form a shell of SiO₂ that partially or fully encapsulates a core of Si. In other words, a surface layer of a Si particle gets oxidized to become SiO₂ and the core portion of the particle remains as Si. By controlling the amount of the encapsulating SiO₂ shell relative to the residual Si core amount, one can obtain particles that already contains both reactants (Si and SiO₂ co-existing in the same particle) that are in a desired molecular ratio and in intimate contact. A powder mass comprising multiple Si/SiO₂ core/shell structured particles is automatically or naturally a uniform “mixture” of the two reactants. This process is further schematically illustrated in FIG. 2.

One may also introduce a desired amount of an element M or a chemical compound (e.g., oxide, nitride, boride, etc.) of M into the internal structure of a starting Si particle (e.g., via ion implementation) or onto the surface of a Si particle (e.g., via sputtering or vapor deposition), but preferably not to fully cover the entire Si particle surface. The Si particles are preferably spherical or ellipsoidal in shape, but there is no limitation on the particle shape. Preferably, the Si particle has a size (diameter) from 20 nm to 50 μm, more preferably from 50 nm to 10 μm, and most preferably from 100 nm to 1 μm. The incorporation of an elemental M or M-containing compound can be controlled to provide enhanced properties of the resulting SiOₓ particles, an anode electrode, and a battery that contains such particles. This will be further discussed later.

In summary, the present disclosure provides a method of producing multiple particles of silicon oxide SiOₓ, where 0<x<2. The method, as illustrated in FIG. 2, comprises: (a) preparing (i) a plurality of silicon alloy particles, M_{y}Si, wherein M is a metal or non-metal element present on a surface of a silicon particle or in the interior of a silicon particle or preparing (ii) a mixture of multiple Si particles and multiple M-containing particles; wherein M is selected from Al, Fe, Zn, Sn, Cu, Mn, Ni, Ti, V, Cr, Co, Zr, Nb, Mo, Ag, Au, Cd, Li, Na, K, Be, Mg, Ca, B, C, Ge, Ga, In, Sb, Bi, N, P, Pb, Se, S, or a combination thereof, and y is selected from 0.001 to 4.4; (b) heating said (i) silicon alloy particles or (ii) mixture of multiple Si particles and multiple M-containing particles to a first temperature for a first period of time to form (iii) a plurality of composite particles or (iv) a mixture of a plurality of composite particles and multiple M-containing particles, wherein a composite particle comprises a layer of silicon dioxide, SiO₂, at least partially covering or encapsulating an underlying silicon alloy or silicon core; (c) heating (iii) the plurality of composite particles or (iv) the mixture to a second temperature under a vacuum or protective inert atmosphere for a second duration of time, allowing the silicon dioxide to react with the underlying silicon alloy or silicon core of a composite particle to form a substantially silicon oxide particle, SiOₓ, having M dispersed therein and vaporizing said silicon oxide to a vapor state; and (d) cooling the silicon oxide vapor to form solid silicon oxide and using mechanical means to make the solid silicon oxide into multiple particles of silicon oxide.

Preferably, the first temperature is from 500° C. to 1,000° C. and the second temperature is from 1,100° C. to 1,500° C. In step (b), a preferred molar ratio of silicon-to-SiO₂ in a composite particle is from 1/100 to 100/1.

Preferably, in the silicon alloy particles M_{y}Si, y is selected from 0.01 to 1.0 and more preferably from 0.1 to 0.3. In certain embodiments, element M, prior to step (b), exists as a single-element metal domain or as a compound of M on a surface or inside the internal structure of a silicon alloy particle. Alloying of Si with other metal elements such as Al, Li, Cu, Zn, Na is well-known in the art. For instance, in the semiconductor industry, Si may be doped with an n-type or p-type dopant to obtain certain improved electronic property (e.g., conductivity). Ion implementation is commonly used to introduce dopants like B into Si. Alternatively, one may simply deposit a layer of M or a M-containing compound to cover portion of the external surface of a Si particle via physical vapor deposition, chemical vapor deposition, sputtering, solution phase deposition, etc.

As such, in certain embodiments of the present disclosure, the element M, upon conclusion of step (c) or (d), exists as a single-element metal domain (a small volume substantially consisting of just M atoms) or as a compound of M inside the internal structure of a silicon oxide particle, or as a compound of M on an external surface of the silicon oxide particle. The element M may be introduced to the interior or surface of a silicon alloy particle by using doping, ion implementation, physical vapor deposition, sputtering, atomic layer deposition, chemical vapor deposition, solution deposition, coating, spraying, painting, or a combination thereof. In some embodiments, the element M, upon conclusion of step (c) or (d), exists as a compound selected from oxide, boride, carbide, nitride, silicide, halogenide, phosphide, or selenide of M, or a combination thereof.

The incorporation of an element M or M-containing compound during the SiOₓ production process led to some unexpected and highly beneficial outcomes. One surprising result is the notion that an anode (negative electrode) that contains SiOₓ particles produced in this manner typically exhibits a significantly lower degree of electrode volume variations (expansion/shrinkage) during battery charging/discharging. This is conducive to a much more stable battery cycling behavior and longer cycle life. Another surprising result is that both the anode active material particles (SiOₓ) and the anode electrode are capable of maintaining structural integrity during battery cycling, substantially avoiding structural failure; e.g., particle pulverization, thus exposing new surfaces to liquid electrolyte that would otherwise consume more electrolyte by forming new solid-electrolyte interphase. These side effects can cause a rapid capacity decay.

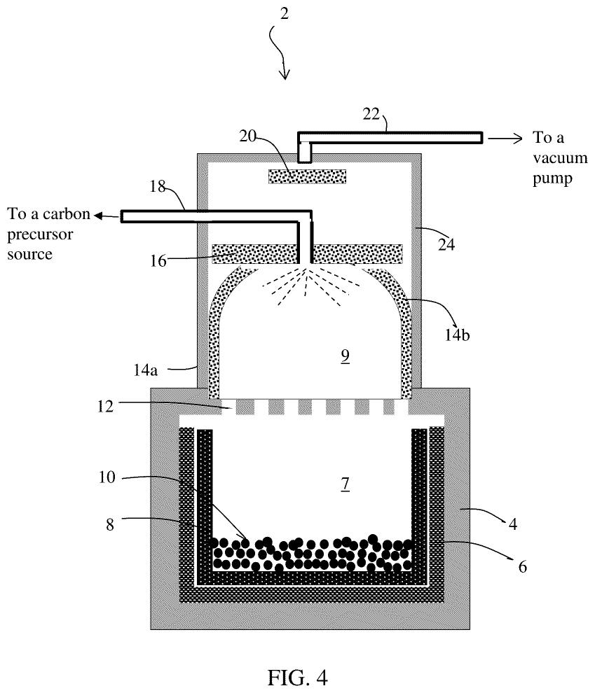

FIG. 4 schematically shows an apparatus 2 that can be used to produce SiOₓ containing M, according to some preferred embodiments of the present disclosure. This apparatus has a supporting body 4 that hosts a crucible 8 to accommodate the starting reactant materials (e.g., Si particles 10 in a first chamber 7). This crucible may be heated by a heating provision (e.g., heating elements 6) that brings the temperature of the reactants to a first temperature (e.g., in the range of 1,100° C. to 1,500° C.) for a second period of time. This higher temperature enables the desired chemical reaction between a Si core and a SiO₂ shell of the same reactant particle under a vacuum or inert gas condition. In one preferred embodiment, a vacuum pump (not shown) is operated to help move the SiOₓ vapor through channels 12 into the second chamber 9, which is disposed in the upper portion (defined by 24) of the apparatus. This second chamber 9 may be cooled to allow the SiOₓ vapor to deposit as a SiOₓ solid onto surfaces of solid collectors 14a, 14b, 16, 20.

An optional stream of carbon precursor source (e.g., acetylene gas) may be introduced through pipe 18 into strategic locations of the second chamber 9, allowing the SiOₓ particles to be covered with a thin layer of carbon (desirably 1-100 nm in thickness).

In certain embodiments, step (c) is conducted in a first chamber (e.g., 7) and step (d) is conducted in a first chamber 7 or a second chamber 9 of a production apparatus and the method further comprises, during step (c) and/or step (d), a procedure (c) of introducing a carbon precursor gas into the first chamber and/or the second chamber and converting the carbon precursor gas into solid carbon that coats or deposits onto a surface of a silicon oxide particle or encapsulates a silicon oxide particle. The carbon precursor gas may be selected from a hydrocarbon gas (e.g., ethylene, propylene, propane, methane, etc.), coal tar pitch gas, petroleum pitch gas, or a combination thereof.

In certain embodiments, the SiOₓ solid deposit may be removed (scratched off) from the solid collectors (14a, 14b, 16, 20) using a mechanical means. The mechanical means in step (d) may be selected from grinding, mechanical milling, air jet milling, or ball-milling.

In certain preferred embodiments, step (c) or step (d) is conducted in a fluidized bed environment to reduce or prevent particle-to-particle bonding, coarsening, or sintering of silicon oxide particles. The SiOₓ vapor is solidified in a moving stream of inert gas. The solidified SiOₓ particles may be pumped out of the second chamber and collected in a bag external to the apparatus 2.

The method may further comprise a step of coating or encapsulating one or a plurality of silicon oxide particles with a thin layer of graphene having a thickness from 0.34 nm to 100 nm. This can be accomplished by dispersing SiOₓ particles and graphene sheets in a liquid medium to form a slurry, which is then spray-dried to form secondary particles containing SiOₓ particles encapsulated by graphene sheets. The graphene material involved in this method may be selected from pristine graphene, graphene oxide (GO), reduced graphene oxide (RGO), graphene fluoride (GF), graphene bromide (GB), graphene iodide (GI), boron-doped graphene, nitrogen-doped graphene, chemically functionalized graphene, or a combination thereof. The graphene material may include a single-layer or few-layer sheet of pristine graphene, graphene oxide, reduced graphene oxide, graphene fluoride, graphene chloride, graphene bromide, graphene iodide, boron-doped graphene, nitrogen-doped graphene, chemically functionalized graphene, or a combination thereof, wherein few layer is defined as less than 10 layers that are stacked together through van der Waals forces with a typical inter-graphene spacing of approximately 0.335 nm or slightly larger.

In certain embodiments, the introduction of the metal or non-metal element M is conducted after (rather than before) the SiOₓ is formed. As such, the present disclosure further provides a method of producing multiple particles of silicon oxide SiOₓ, where 0<x<2, the method comprising: (a) preparing a plurality of silicon particles; (b) heating said silicon particles to a first temperature for a first period of time to form a plurality of composite particles, wherein a composite particle comprises a layer of silicon dioxide, SiO₂, at least partially covering or encapsulating an underlying silicon; (c) heating the plurality of composite particles to a second temperature under a vacuum or protective inert atmosphere for a second duration of time, allowing the silicon dioxide to react with the underlying silicon of a composite particle to form a silicon oxide particle and vaporizing said silicon oxide to a vapor state; (d) introducing a stream of a precursor gas containing an element M to mix and react with the silicon oxide vapor to form vapor of M-containing silicon oxide, wherein M is a metal or non-metal element selected from Al, Fe, Zn, Sn, Cu, Mn, Ni, Ti, V, Cr, Co, Zr, Nb, Mo, Ag, Au, Cd, Li, Na, K, Be, Mg, Ca, B, C, Ge, Ga, In, Sb, Bi, N, P, Pb, Se, S, or a combination thereof, and M is present on a surface of a silicon oxide particle or in the interior of a silicon oxide and the atomic ratio of M-to-Si in the M-containing silicon oxide is selected from 0.001 to 4.4; and (e) cooling the M-containing silicon oxide vapor to form M-containing solid silicon oxide and using mechanical means to make said solid silicon oxide into multiple particles of silicon oxide containing M therein.

The present disclosure also provides an anode active material for lithium-ion batteries. The anode active material comprises a plurality of composite particles wherein at least a composite particle (preferably having a diameter of from 50 nm to 50 μm) comprises (i) one or more than one silicon oxide SiOₓ particle (where 0<x<2), and (ii) a metal or semi-metal element M dispersed in the SiOₓ matrix (the bulk) of the particle or coated on a surface of the SiOₓ particle and M is selected from Al, Fe, Zn, Sn, Cu, Mn, Ni, Ti, V, Cr, Co, Zr, Nb, Mo, Ag, Au, Cd, Li, Na, K, Be, Mg, Ca, B, C, Ge, Ga, In, Sb, Bi, N, P, Pb, Se, S, or a combination thereof, and wherein M is present as individual M atoms embedded in the SiOₓ structure, as a domain or phase comprising multiple M atoms that are dispersed in the SiOₓ structure, or as a compound selected from oxide, boride, carbide, nitride, silicide, halogenide, phosphide, or selenide of M, or a combination thereof.

In some preferred embodiments, in this anode active material, the composite comprises discrete, oxygen-free Si domains or phase dispersed in a SiOₓ matrix wherein the Si domains have a dimension from 2 nm to 200 nm.

In some specific embodiments, the composite particle is a core/shell structure comprising a core of discrete, oxygen-free Si domain or phase encapsulated by a shell of SiOₓ matrix, wherein the Si domain core has a dimension from 10 nm to 200 nm.

### Example 1: Preparation of SiOₓ from Lithium-Doped Silicon Particles Alone (No SiO₂ Present in the Reactant)

In an experiment, a sample of 5 kg Li-doped silicon powder having particle sizes of 0.5-2.1 μm (supplied from Angstron Energy Co., Dayton, Ohio) was placed in a high-temperature furnace, FIG. 4. The apparatus was then heated to 800° C. and maintained at this temperature for 6 hours under a room air condition (exposing to oxygen in the air) to induce oxidation of Si on the surface of each Li-doped Si particle, forming a shell layer of SiO₂ encapsulating an underlying doped Si core. The furnace was then pumped to a vacuum pressure of 10 Pa and heated to 1350° C., maintaining at this temperature for 3 hours, enabling reactions between a SiO₂ shell and a Si core to produce SiOₓ. The temperature was also sufficient to sublime the reaction product (Li-containing SiOₓ) into a vapor state. The Li-containing SiOₓ vapor was flowed into the upper portion (second chamber) of the apparatus where the vapor was cooled and deposited onto a surface of a solid collector. The SiOₓ solid deposit was removed from the collector surfaces and pulverized into smaller particles.

A comparative example sample of SiOₓ (herein referred to as Comparative Example 1) was prepared in a similar manner with the exception that the starting material was Si without any pre-doping.

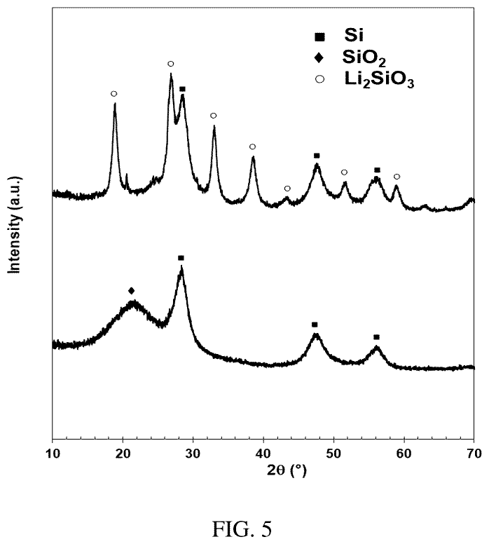

The X-ray diffraction curve of Example 1 and that of Comparative Example 1 are shown in FIG. 5, indicating the chemical compositions of Example 1 contain Si, SiO₂, and Li₂SiO₃. SEM and TEM studies indicate that the composite comprises discrete, oxygen-free Si domains dispersed in a SiOₓ matrix wherein the Si domains have a dimension from 2 nm to 155 nm. Very fine, nano-scaled Li₂SiO₃ domains were uniformly dispersed in both the Si and SiO₂ phase.

In one example, a carbon precursor gas (mixture of argon and acetylene at a volume ratio of 5/2) was introduced into the chamber containing Li-containing SiOₓ vapor to produce carbon-coated Li-containing SiOₓ solid particles.

For electrochemical testing, the working electrodes were prepared by mixing 90 wt. % active material (carbon-encapsulated or non-encapsulated particulates of SiOₓ, separately), 5 wt. % acetylene black (Super-P), and 5 wt. % polyvinylidene fluoride (PVDF) binder dissolved in N-methyl-2-pyrrolidinoe (NMP) to form a slurry of 5 wt. % total solid content. After coating the slurries on Cu foil, the electrodes were dried at 120° C. in vacuum for 2 h to remove the solvent before pressing. Then, the electrodes were cut into a disk (ϕ=12 mm) and dried at 100° C. for 24 h in vacuum. Electrochemical measurements were carried out using CR2032 (3V) coin-type cells with lithium metal as the counter/reference electrode, Celgard 2400 membrane as separator, and 1 M LiPF₆ electrolyte solution dissolved in a mixture of ethylene carbonate (EC) and diethyl carbonate (DEC) (EC-DEC, 1:1 v/v). The cell assembly was performed in an argon-filled glove-box. The CV measurements were carried out using an electrochemical workstation at a scanning rate of 1 mV/s.

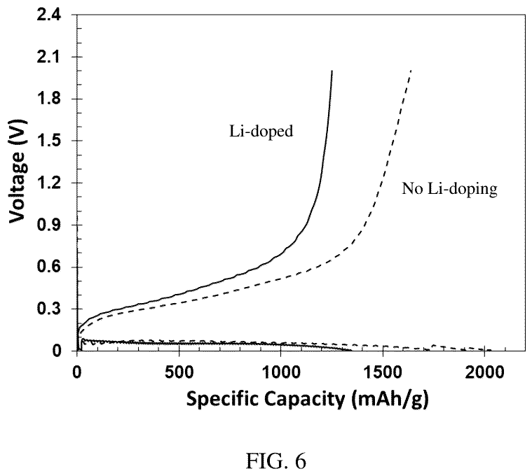

The prepared button half-cells were also tested in a constant current charge-discharge mode using a charge-discharge meter, with a discharge cut-off voltage of 0.005V, a charging cut-off voltage of 2V, and a charge and discharge test of 0.1C current density in the first week. The first-cycle Coulombic efficiency and specific capacity of all cells were measured. We have observed that the first cycle efficiency of the Li-containing SiOₓ anode prepared according to the presently disclosed method is typically in the range of 92-94%, in contrast to typically 78-82% of SiOₓ anodes prepared by using the presently disclosed process (but without doping by a third element M). Although without the presence of M, the anode can store more charges per unit anode mass, the excessively low first-cycle efficiency is known as a highly detrimental problem for SiOₓ-based anode material (FIG. 6).

Further, the first-cycle efficiency is typically in the range of 72-78% for SiOₓ anodes prepared by using prior art processes that begin with the preparation of Si and SiO₂ separately, followed by mixing and reaction.

Full-cell tests were also conducted. For the preparation of an anode, the SiOₓ material and graphite were mixed and configured in a composite with a specific capacity of 450 mAh/g. The anode active material mixture, conductive additive, and the binder were weighed and mixed in a ratio of 95%:2%:3%. At room temperature, the mixed material and solvent (deionized water) were made into a slurry, which was evenly coated on the copper foil, and dried at a temperature between 70-100° C.

The preparation of the cathode piece was obtained according to the ratio of 96%: 2%: 2% weighed nickel-cobalt manganate lithium (NMC) ternary cathode material, conductive additive and binder. At room temperature, the three component materials were dispersed in NMP to form a slurry. The prepared slurry was evenly coated on the aluminum foil and dried at 90-120° C.

In the preparation of a full cell, the positive electrode (cathode) sheet had aluminum tabs as exposed tabs, the negative electrode (anode) sheet using copper plated Nickel tabs as exposed tabs. The prepared positive and negative electrode sheets and separators were wound into dry cells, and then the cells are encapsulated by the heat sealing process using aluminum plastic film, baked in a high temperature vacuum oven to remove the moisture in the battery, and then injected with 1 mole of electrolyte. The electrolyte, a mixed solution of LiPF₆ and vinyl carbonate/dimethyl carbonate (EC/DMC), was injected into a cell and vacuum sealed to obtain a battery cell.

The electrochemical behaviors of the full cells were characterized by using a charge-discharge meter for constant current charge-discharge mode test with a discharge cut-off voltage of 2.75V and charging cut-off voltage is 4.2V. The discharge test after the first week was carried out at a current density of 10C rate.

The electrode expansion rate test was conducted in the following manner: After the battery cells were fully charged/discharged for 300 cycles and 600 cycles, respectively, 5 cells each were dismounted from the testing station. The cell was open and the negative electrode piece was removed. The thickness of 10 different areas of each electrode was measured with a thickness gauge, and the average value was taken. Under the same test conditions, the average thickness of the electrode in the initial state was obtained as well.

The calculation formula used is: the full expansion rate of the electrode=(the average thickness of the electrode when a desired number of cycles was reached—the initial average of the electrode thickness)/initial average thickness of the electrode piece. The obtained data are listed in Table 1.

### Example 2: Preparation of SiOₓ from Si, Lithium Hydride, and Boron Oxide Particles

The process was similar to that described in Example 1 with the exception that the starting materials were different. In an experiment, 5 kg silicon powder (not previously doped) having a diameter of 80-150 nm, 190 g boron oxide, and 130 g lithium hydride were mixed evenly and placed in a high-temperature furnace. The apparatus was then heated to 800° C. and maintained at this temperature for 6 hours under a room air condition (exposing to oxygen in the air) to induce oxidation of Si on the surface of each Si particle, forming a shell layer of SiO₂ encapsulating an underlying Si core. The furnace was then pumped to a vacuum pressure of 10 Pa and heated to 1350° C., maintaining at this temperature for 3 hours, enabling reactions between a SiO₂ shell and a Si core, along with boron oxide and lithium hydride, to produce B/Li-containing SiOₓ. The temperature was also sufficient to sublime the reaction product (B/Li-containing SiOₓ) into a vapor state. The B/Li-containing SiOₓ vapor was flowed into the upper portion (second chamber) of the apparatus where the vapor was cooled and deposited onto a surface of a solid collector. The SiOₓ solid deposit was removed from the collector surfaces and pulverized into smaller particles. Similar electrochemical tests as those described in Example 1 were performed and the data are given in Table 1.

### Example 3: Preparation of SiOₓ from Si and Magnesium Oxide Powder

The process was similar to that described in Example 2. In one example, 6.0 kg Si and 230 g magnesium oxide were mixed evenly and placed in a high temperature vacuum furnace. The apparatus was then heated to 600° C. and maintained at this temperature for 6 hours under a room air condition (exposing to oxygen in the air) to induce oxidation of Si on the surface of each Si particle, forming a shell layer of SiO₂ encapsulating an underlying Si core. The furnace was then pumped to a vacuum pressure of 50 Pa and heated to 1200° C., maintaining at this temperature for 3 hours, enabling reactions between a SiO₂ shell and a Si core, along with magnesium oxide, to produce Mg-containing SiOₓ. The temperature was also sufficient to sublime the reaction product (Mg-containing SiOₓ) into a vapor state. The Mg-containing SiOₓ vapor was flowed into the upper portion (second chamber) of the apparatus. A mixture of natural gas and propane at a volume ratio of 1:2 was then introduced into the upper chamber, allowing for carbon encapsulation of and/or mixing with Mg-containing SiOₓ particles. Similar electrochemical tests as those described in Example 1 were performed and the data are given in Table 1.

### Example 4: Preparation of SiOₓ from Si, Sulfur (S), and Tin-Nickel Alloy

The process was similar to that described in Example 3, but the carbon coating procedure was carried out in a separate apparatus. In one example, 5.0 kg Si, 500 g sulfur powder, and 200 g tin-nickel alloy were mixed evenly and placed in a high temperature vacuum furnace. The apparatus was then heated to 600° C. and maintained at this temperature for 3 hours under a room air condition (exposing to oxygen in the air) to induce oxidation of Si on the surface of each Si particle, forming a shell layer of SiO₂ encapsulating an underlying Si core. The furnace was then pumped to a vacuum pressure of 20 Pa and heated to 1,050° C., maintaining at this temperature for 2 hours, enabling reactions between a SiO₂ shell and a Si core, along with sulfur and tin-nickel alloy, to obtain a gaseous mixture. This gaseous mixture was then cooled to deposit on the solid deposit collectors (FIG. 4). After scratching off, crushing and screening the solid deposit, a Ni/Sn/S-containing silicon oxide material was obtained.

For the carbon coating, 1 kg of the obtained SiOₓ material and some asphalt at a ratio of 20:1 were dispersed or dissolved in isopropanol and stirred for 4 hours to form a homogeneous slurry. Subsequently, the slurry was dried, placed in a rotary furnace, heated to 750° C. in a protective atmosphere for 2.5 hours. After cooling, discharging from the rotary furnace and grading, one obtained a carbon-coated SiOₓ anode material. Similar electrochemical tests as those described in Example 1 were performed and the data are given in Table 1.

### Example 5: Fabrication of SiOₓ Anode Material from Si, Zinc Oxide, and Black Phosphorus Particles

The process was similar to that described in Example 3, but the carbon coating procedure was carried out in a separate apparatus. In one example, 5 kg silicon powder, 300 g zinc oxide and 50 g black phosphorus were mixed evenly and placed in a high temperature vacuum furnace. The apparatus was then heated to 600° C. and maintained at this temperature for 2 hours under a room air condition (exposing to oxygen in the air) to induce oxidation of Si on the surface of each Si particle, forming a shell layer of SiO₂ encapsulating an underlying Si core. The furnace was then pumped to a vacuum pressure of 120 Pa and heated to 1.050° C., maintaining at this temperature for 2.5 hours, enabling reactions between a SiO₂ shell and a Si core, along with zinc oxide, and black phosphorus, to obtain a gaseous mixture. This gaseous mixture was then cooled to deposit on the solid deposit collectors (FIG. 4). After scratching off, crushing and screening the solid deposit, a Zn/P-containing silicon oxide material was obtained.

The obtained SiOₓ anode material was carbon coated in the following manner: 1 kg SiOₓ-based composite material with a phenolic resin in a ratio of 13:1 was dissolved in tetrahydrofuran and stirred for 5 hours to form a homogeneous slurry. After that, the slurry was dried, placed in a rotary furnace, heated to 850° C. in a protective atmosphere for 1 hour. Upon cooling, discharging from the rotary furnace, and grading, a carbon-coated SiOₓ anode material was obtained. Similar electrochemical tests as those described in Example 1 were performed and the data are given in Table 1.

### Example 6: Fabrication of SiOₓ Anode Material from Si and Alumina Particles

The process was similar to that described in Example 2. In one example, 5.0 kg Si and 260 g alumina were mixed evenly and placed in a high temperature vacuum furnace. The apparatus was then heated to 600° C. and maintained at this temperature for 6 hours under a room air condition (exposing to oxygen in the air) to induce oxidation of Si on the surface of each Si particle, forming a shell layer of SiO₂ encapsulating an underlying Si core. The furnace was then pumped to a vacuum pressure of 80 Pa and heated to 1100° C., maintaining at this temperature for 3 hours, enabling reactions between a SiO₂ shell and a Si core, along with magnesium oxide, to produce Al-containing SiOₓ. The temperature was also sufficient to sublime the reaction product (Al-containing SiOₓ) into a vapor state. The Al-containing SiOₓ vapor was flowed into the upper portion (second chamber) of the apparatus. Approximately 50 Lof acetylene gas was then introduced into the upper chamber, allowing for carbon encapsulation of and/or mixing with Al-containing SiOₓ particles. Similar electrochemical tests as those described in Example 1 were performed and the data are given in Table 1.

### Example 7: Fabrication of SiOₓ Anode Material from Si and Selenium Dioxide Particles

The process was similar to that described in Example 3, but the carbon coating procedure was carried out in a separate apparatus. In one example, 3 kg silicon powder and 90 g selenium dioxide were mixed evenly and placed in a high temperature vacuum furnace. The apparatus was then heated to 750° C. and maintained at this temperature for 2 hours under a room air condition to induce oxidation of Si on the surface of each Si particle, forming a shell layer of SiO₂ encapsulating an underlying Si core. The furnace was then pumped to a vacuum pressure of 80 Pa and heated to 1,050° C., maintaining at this temperature for 2 hours, enabling reactions between a SiO₂ shell and a Si core, along with selenium dioxide, to obtain a gaseous mixture. This gaseous mixture was then cooled to deposit on the solid deposit collectors (FIG. 4). After scratching off, crushing and screening the solid deposit, a Se-containing silicon oxide material was obtained.

The obtained SiOₓ anode material was carbon coated in the following manner: SiOₓ-based composite material and a petroleum pitch at a ratio of 20:1 was mixed and stirred for 5 hours to form a homogeneous slurry. After that, the slurry was dried, placed in a rotary furnace, heated to 950° C. in a protective atmosphere for 1.5 hour. Upon cooling, discharging from the rotary furnace, and grading, a carbon-coated SiOₓ anode material was obtained. Similar electrochemical tests as those described in Example 1 were performed and the data are given in Table 1.

### Comparative Example 1: Fabrication of SiOₓ Anode Material from Si Particles Alone

In an experiment, a sample of 5 kg silicon powder (no doping) having particle sizes of 0.6-2.3 μm was placed in a high-temperature furnace, FIG. 4. The apparatus was then heated to 800° C. and maintained at this temperature for 6 hours under a room air condition (exposing to oxygen in the air) to induce oxidation of Si on the surface of each Si particle, forming a shell layer of SiO₂ encapsulating an underlying doped Si core. The furnace was then pumped to a vacuum pressure of 10 Pa and heated to 1350° C., maintaining at this temperature for 3 hours, enabling reactions between a SiO₂ shell and a Si core to produce SiOₓ. The temperature was also sufficient to sublime the reaction product (SiOₓ) into a vapor state. The SiOₓ vapor was flowed into the upper portion (second chamber) of the apparatus where the vapor was cooled and deposited onto a surface of a solid collector. The SiOₓ solid deposit was removed from the collector surfaces and pulverized into smaller particles. A carbon precursor gas (mixture of argon and acetylene at a volume ratio of 5/2) was introduced into the chamber containing SiOₓ vapor to produce carbon-coated SiOₓ solid particles.

### Comparative Example 2: Fabrication of SiOₓ Anode Material from a Mixture of Si and SiO₂ Particles

In an experiment, 2.5 kg silicon powder (no doping) and 2.5 kg silica powder were mechanically mixed to obtain a solid mixture, which was placed in a high temperature furnace. The furnace was pumped to a vacuum pressure of 10 Pa and heated to 1350° C., maintaining at this temperature for 3 hours, enabling reactions between Si and SiO₂ to produce SiOₓ. The temperature was sufficient to sublime the reaction product (SiOₓ) into a vapor state. The SiOₓ vapor was flowed into the upper portion (second chamber) of the apparatus where the vapor was cooled and deposited onto a surface of a solid collector. The SiOₓ solid deposit was removed from the collector surfaces and pulverized into smaller particles. A carbon precursor gas (mixture of argon and acetylene at a volume ratio of 5/2) was introduced into the chamber containing SiOₓ vapor to produce carbon-coated SiOₓ solid particles.

### Comparative Example 3: Preparation of SiOₓ from a Mixture of Si, SiO₂, and Magnesium Oxide Particles

In one example, 3.0 kg Si, 2.5 kg SiO₂, and 230 g magnesium oxide were mixed evenly and placed in a high temperature vacuum furnace. The apparatus was then pumped to a vacuum pressure of 50 Pa and heated to 1200° C., maintaining at this temperature for 4 hours, enabling reactions between Si and SiO₂ particles, along with magnesium oxide, to produce Mg-containing SiOₓ. The temperature was also sufficient to sublime the reaction product (Mg-containing SiOₓ) into a vapor state. The Mg-containing SiOₓ vapor was flowed into the upper portion (second chamber) of the apparatus. A mixture of natural gas and propane at a volume ratio of 1:2 was then introduced into the upper chamber, allowing for carbon encapsulation of and/or mixing with Mg-containing SiOₓ particles. Similar electrochemical tests as those described in Example 3 were performed and the data are given in Table 1.

TABLE 1
Electrochemical testing data.

| | | Reversible | Capacity | Anode | Anode |
|---|---|---|---|---|---|
| Example (E) or | | capacity at | retention (%) | expansion (%) | expansion (%) |
| Comparative | 1^{st}-cycle | 0.1 C | after 600 | after 300 | after 600 |
| Example (CE) | Efficiency | (mAh/g) | cycles at 10 C | cycles at 10 C | cycles at 10 C |
| E1 | 93.5 | 1440 | 96 | 12.8 | 14.6 |
| E2 | 92.5 | 1485 | 95 | 13.1 | 15.1 |
| E3 | 91.9 | 1478 | 95 | 13.3 | 15.4 |
| E4 | 92.1 | 1489 | 95 | 13.2 | 14.8 |
| E5 | 91.6 | 1508 | 94 | 13.4 | 15.2 |
| E6 | 91.4 | 1502 | 94 | 13.5 | 15.4 |
| E7 | 91.1 | 1506 | 93 | 13.8 | 15.5 |
| CE1 | 81 | 1824 | 82 | 18.2 | 27.6 |
| CE2 | 77 | 1706 | 76 | 19.9 | 34.2 |
| CE3 | 82 | 1455 | 83 | 16.6 | 23.3 |

We have conducted an extensive and in-depth study on a new method of producing silicon oxide (SiOₓ) anode materials for use in a lithium-ion cell. The following is a summary of some of the more significant observations or conclusions: A facile and cost-effective method of mass-producing silicon oxide and carbon-coated silicon oxide powder has been developed. The SiOₓ-based anode materials doped with an element M provide the best performance in terms of delivering a high first-cycle efficiency and maintaining a high capacity for a long cycle life as compared to the SiOₓ anode active materials prepared by using prior art processes and/or those containing no doping by an element M, wherein M is preferably selected from Al, Fe, Zn, Sn, Cu, Mn, Ni, Ti, V, Cr, Co, Zr, Nb, Mo, Ag, Au, Cd, Li, Na, K, Be, Mg, Ca, B, C, Ge, Ga, In, Sb, Bi, N, P, Pb, Se, S, or a combination thereof.

We claim:

1. A method of producing multiple particles of silicon oxide SiOₓ, where 0<x<2, said method comprising:
(a) preparing (i) a plurality of silicon alloy particles, M_{y}Si, wherein M is a metal or non-metal element present on a surface of a silicon particle or in the interior of a silicon particle or preparing (ii) a mixture of multiple Si particles and multiple M-containing particles; wherein M is selected from Al, Fe, Zn, Sn, Cu, Mn, Ni, Ti, V, Cr, Co, Zr, Nb, Mo, Ag, Au, Cd, Li, Na, K, Be, Mg, Ca, B, C, Ge, Ga, In, Sb, Bi, N, P, Pb, Se, S, or a combination thereof, and y is selected from 0.001 to 4.4;
(b) heating said (i) silicon alloy particles or (ii) mixture of multiple Si particles and multiple M-containing particles to a first temperature for a first period of time to form (iii) a plurality of composite particles or (iv) a mixture of a plurality of composite particles and multiple M-containing particles, wherein a composite particle comprises a layer of silicon dioxide, SiO₂, at least partially covering or encapsulating an underlying silicon alloy or silicon core;
(c) heating (iii) the plurality of composite particles or (iv) the mixture to a second temperature under a vacuum or protective inert atmosphere for a second duration of time, allowing the silicon dioxide to react with the underlying silicon alloy or silicon core of a composite particle to form a substantially silicon oxide particle, SiOₓ, having M dispersed therein and vaporizing said silicon oxide to a vapor state; and
(d) cooling the silicon oxide vapor to form solid silicon oxide and using mechanical means to make said solid silicon oxide into multiple particles of silicon oxide containing M therein.

2. A method of producing multiple particles of silicon oxide SiOₓ, where 0<x<2, said method comprising: (a) preparing a plurality of silicon particles; (b) heating said silicon particles to a first temperature for a first period of time to form a plurality of composite particles, wherein a composite particle comprises a layer of silicon dioxide, SiO₂, at least partially covering or encapsulating an underlying silicon; (c) heating the plurality of composite particles to a second temperature under a vacuum or protective inert atmosphere for a second duration of time, allowing the silicon dioxide to react with the underlying silicon of a composite particle to form a silicon oxide particle and vaporizing said silicon oxide to a vapor state; (d) introducing a stream of a precursor gas containing an element M to mix and react with the silicon oxide vapor to form vapor of M-containing silicon oxide, wherein M is a metal or non-metal element selected from Al, Fe, Zn, Sn, Cu, Mn, Ni, Ti, V, Cr, Co, Zr, Nb, Mo, Ag, Au, Cd, Li, Na, K, Be, Mg, Ca, B, C, Ge, Ga, In, Sb, Bi, N, P, Pb, Se, S, or a combination thereof, and M is present on a surface of a silicon oxide particle or in the interior of a silicon oxide and the atomic ratio of M-to-Si in the M-containing silicon oxide is selected from 0.001 to 4.4; and (e) cooling the M-containing silicon oxide vapor to form M-containing solid silicon oxide and using mechanical means to make said solid silicon oxide into multiple particles of silicon oxide containing M therein.

3. The method of claim 1, wherein y is selected from 0.01 to 1.0.

4. The method of claim 1, wherein said element M, prior to step (b), exists as a single-element metal domain or as a compound of M on a surface or inside the internal structure of a silicon alloy particle.

5. The method of claim 1, wherein said element M, upon conclusion of step (c) or (d), exists as a single-element metal domain or as a compound of M inside the internal structure of a silicon oxide particle, or as a compound of M on an external surface of the silicon oxide particle.

6. The method of claim 1, wherein said element M, upon conclusion of step (c) or (d), exists as a compound selected from oxide, boride, carbide, nitride, silicide, halogenide, phosphide, or selenide of M, or a combination thereof.

7. The method of claim 1, wherein said M is introduced to the interior or surface of a silicon alloy particle by using doping, ion implementation, physical vapor deposition, sputtering, atomic layer deposition, chemical vapor deposition, solution deposition, coating, spraying, painting, or a combination thereof.

8. The method of claim 1, wherein a molar ratio of silicon-to-SiO₂ in a composite particle is from 1/100 to 100/1.

9. The method of claim 1, wherein the first temperature is from 500° C. to 1,000° C. and the second temperature is from 1,100° C. to 1,500° C.

10. The method of claim 1, wherein step (c) is conducted in a first chamber and step (d) is conducted in a first chamber or a second chamber and the method further comprises, during step (c) and/or step (d), a procedure (e) of introducing a carbon precursor gas into the first chamber and/or the second chamber and converting the carbon precursor gas into solid carbon that coats or deposits onto a surface of a silicon oxide particle or encapsulates a silicon oxide particle.

11. The method of claim 10, wherein the carbon precursor gas is selected from a hydrocarbon gas, coal tar pitch gas, petroleum pitch gas, or a combination thereof.

12. The method of claim 1, wherein said mechanical means in step (d) is selected from grinding, mechanical milling, air jet milling, or ball-milling.

13. The method of claim 1, wherein said step (c) or step (d) is conducted in a fluidized bed environment to reduce or prevent particle-to-particle bonding, coarsening, or sintering of silicon oxide particles.

14. The method of claim 1, further comprising a step of coating or encapsulating a silicon oxide particle with a thin layer of carbon or graphene having a thickness from 0.34 nm to 100 nm.

15. An anode active material for lithium-ion batteries, said anode active material comprising a plurality of composite particles wherein at least a composite particle, having a diameter of from 50 nm to 50 μm, comprises (i) one or more than one silicon oxide SiOₓ particle, where 0<x<2, and (ii) a metal or non-metal element M dispersed in said SiOₓ particle or coated on a surface of the SiOₓ particle and M is selected from Al, Fe, Zn, Sn, Cu, Mn, Ni, Ti, V, Cr, Co, Zr, Nb, Mo, Ag, Au, Cd, Li, Na, K, Be, Mg, Ca, B, C, Ge, Ga, In, Sb, Bi, N, P, Pb, Se, S, or a combination thereof, and wherein M is present as individual M atoms embedded in the SiOₓ structure, as a domain or phase comprising multiple M atoms that are dispersed in the SiOₓ structure, or as a compound selected from an oxide, boride, carbide, nitride, silicide, halogenide, phosphide, or selenide of M, or a combination thereof.

16. The anode active material of claim 15, wherein the composite comprises discrete, oxygen-free Si domains or phase dispersed in a SiOₓ matrix wherein the Si domains have a dimension from 2 nm to 200 nm.

17. The anode active material of claim 15, wherein the composite particle is a core/shell structure comprising a core of discrete, oxygen-free Si domain or phase encapsulated by a shell of SiOₓ, wherein the Si domain core has a dimension from 10 nm to 200 nm.

18. The anode active material of claim 15, wherein the composite particle is further encapsulated by or coated with a layer of carbon or graphene.

19. An anode for a lithium battery, wherein said anode comprises the anode active material of claim 15 as an anode material.

20. The anode of claim 19, further including a binder.

21. The anode of claim 20, further including a conductive additive.

22. The anode of claim 19, further including a conductive additive.

23. A lithium battery, wherein said lithium battery comprises an anode of claim 19, a cathode, a separator between the anode and the cathode, and an electrolyte in ionic contact with the anode and the cathode.
